(19) United States
(12) Patent Application Publication
(10) Pub. No.: US 2025/0116916 A1
(43) Pub. Date: Apr. 10, 2025

(54) CAMERA MODULE AND ELECTRONIC DEVICE

(71) Applicant: LARGAN PRECISION CO., LTD., Taichung City (TW)

(72) Inventors: Lin-An CHANG, Taichung City (TW); Ming-Ta CHOU, Taichung City (TW); Te-Sheng TSENG, Taichung City (TW)

(21) Appl. No.: 18/818,989

(22) Filed: Aug. 29, 2024

(30) Foreign Application Priority Data
Oct. 6, 2023 (TW) 112138612

(51) Int. Cl. G03B 13/36

(52) U.S. Cl. CPC G03B 13/36

(57) ABSTRACT

A camera module includes an imaging lens assembly, an image sensor and a magnet assembling mechanism. The image sensor is for receiving an image signal of the imaging lens assembly. The magnet assembling mechanism is for defining a status of the image signal of the imaging lens assembly corresponding to the image sensor, wherein the magnet assembling mechanism includes a magnet holder, a magnet and an opaque layer. The magnet is disposed at the magnet holder. The opaque layer is disposed on an outer surface of the magnet.

### RELATED APPLICATIONS

This application claims priority to Taiwan Application Serial Number 112138612, filed Oct. 6, 2023, which is herein incorporated by reference.

### BACKGROUND

### Technical Field

The present disclosure relates to a camera module. More particularly, the present disclosure relates to a camera module applicable to portable electronic devices.

### Description of Related Art

In recent years, portable electronic devices have developed rapidly. For example, intelligent electronic devices and tablets have been filled in the lives of modern people, and camera modules mounted on portable electronic devices have also prospered. However, as technology advances, the quality requirements of the camera module are becoming higher and higher. Therefore, a camera module, which can enhance the image quality, needs to be developed.

### SUMMARY

According to one aspect of the present disclosure, a camera module includes an imaging lens assembly, an image sensor and a magnet assembling mechanism. The image sensor is for receiving an image signal of the imaging lens assembly. The magnet assembling mechanism is for defining a status of the image signal of the imaging lens assembly corresponding to the image sensor. The magnet assembling mechanism includes a magnet holder, a magnet and an opaque layer, wherein the magnet is disposed at the magnet holder, the opaque layer is disposed on an outer surface of the magnet.

According to one aspect of the present disclosure, an electronic device includes the camera module of the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1A is an exploded schematic view of a camera module according to the 1st embodiment of the present disclosure.

FIG. 1B is a schematic view of a first magnet holder and an opaque layer of the camera module of FIG. 1A.

FIG. 1C is a schematic view of the first magnet holder, the first magnets and the opaque layer of the 1st example according to the 1st embodiment of FIG. 1A.

FIG. 1D is an enlarged schematic view of the portion 1D in FIG. 1C.

FIG. 1E is a schematic view of the first magnet holder, the first magnets and the opaque layer of the 2nd example according to the 1st embodiment of FIG. 1A.

FIG. 1F is an enlarged schematic view of the portion 1F in FIG. 1E.

FIG. 1G is an enlarged schematic view of the opaque layer, the micron particles and nano protrusions on the first magnet of the 3rd example according to the 1st embodiment of FIG. 1A.

FIG. 1H is an enlarged schematic view of the opaque layer, the micron particles and nano holes on the first magnet of the 4th example according to the 1st embodiment of FIG. 1A.

FIG. 2A is a schematic view of a camera module according to the 2nd embodiment of the present disclosure.

FIG. 2B is a three-dimensional schematic view of the magnet holder, the magnets and the opaque layers of the 1st example according to the 2nd embodiment of FIG. 2A.

FIG. 2C is a schematic view of the magnets, the opaque layers and an adhesive material of the 1st example according to the 2nd embodiment of FIG. 2B.

FIG. 2D is a three-dimensional schematic view of the magnet holder and the opaque layers of the 2nd example according to the 2nd embodiment of FIG. 2A.

FIG. 2E is a schematic view of the magnets, the opaque layers and an adhesive material of the 2nd example according to the 2nd embodiment of FIG. 2D.

FIG. 3A is an exploded schematic view of a camera module according to the 3rd embodiment of the present disclosure.

FIG. 3B is a schematic view of a magnet holder, the magnets and opaque layers of the camera module of FIG. 3A.

FIG. 4A is a schematic view of an electronic device according to the 4th embodiment of the present disclosure.

FIG. 4B is another schematic view of the electronic device according to the 4th embodiment of FIG. 4A.

FIG. 4C is a schematic view of an image captured via the electronic device according to the 4th embodiment of FIG. 4A.

FIG. 4D is another schematic view of the image captured via the electronic device according to the 4th embodiment of FIG. 4A.

FIG. 4E is the other schematic view of the image captured via the electronic device according to the 4th embodiment of FIG. 4A.

FIG. 5 is a schematic view of an electronic device according to the 5th embodiment of the present disclosure.

FIG. 6A is a schematic view of a vehicle instrument according to the 6th embodiment of the present disclosure.

FIG. 6B is another schematic view of the vehicle instrument according to the 6th embodiment in FIG. 6A.

FIG. 6C is another schematic view of the vehicle instrument according to the 6th embodiment in FIG. 6A.

### DETAILED DESCRIPTION

The present disclosure provides a camera module, which includes an imaging lens assembly, an image sensor and a magnet assembling mechanism. The image sensor is for receiving an image signal of the imaging lens assembly. The magnet assembling mechanism is for defining a status of the image signal of the imaging lens assembly corresponding to the image sensor. The magnet assembling mechanism includes a magnet holder, a magnet and an opaque layer. The magnet is disposed at the magnet holder. The opaque layer is disposed on an outer surface of the magnet. Therefore, the present disclosure provides the camera module with the magnet, and the surface of the magnet with opaque layer, so that it is favorable for decreasing the possibility of the generation of the stray light by providing the matte magnet to avoid the surface of the magnet with metallic luster. Further, due to the condition of the image signal of the imaging lens assembly would be changed by the movement between the mechanisms, such as the magnet assembling mechanism, part of light in the camera module would lead the situation which is unexpected for the light simulation. Thus, it is favorable for ensuring the quality of the image signal by reducing the possibility of the foregoing situation via the design of the present disclosure.

Specifically, the magnet assembling mechanism can be a dynamic moving-coil driving mechanism or a moving-magnet driving mechanism. The dynamic moving-coil driving mechanism can have a fixed magnet holder or have both of a movable magnet holder and a fixed magnet holder. The moving-magnet driving mechanism can have a movable magnet holder or have both movable magnet holder and a fixed magnet holder. The present disclosure will not be limited thereto.

The condition defined by the magnet assembling mechanism is that, the magnet assembling mechanism can be configured for achieving the auto-focus function of the camera module, the image stabilization of the camera module, the f-number adjusting function of the camera module and the circuit controlling function of the camera module; that is, the aforementioned functions are specific embodiments for defining the conditions of the image signal of the imaging lens assembly relative to the image sensor, and the present disclosure will not be limited thereto.

Further, the magnet can be disposed at the magnet holder via adhesive material, or be magnetically attached at the magnet holder directly, but the present disclosure will not be limited thereto.

The opaque layer can have a part facing towards a direction towards the image sensor. Due to the non-imaging light with high intensity is easily generated at the location where the magnet assembling mechanism close to the image sensor, thus, it is favorable for effectively avoiding the non-imaging light incident into the image sensor.

The magnet assembling mechanism can further include a coil, the magnet and the coil are disposed relatively. Therefore, a driving force for the magnet assembling mechanism can be provided by correspondingly disposing the magnet and the coil, so that the dynamic change of the image signal can be provided.

The magnet assembling mechanism can further include a magnet sensing element, the magnet and the magnet sensing element disposed relatively. Therefore, it is favorable for controlling the sensitivity by the magnet assembling mechanism.

The magnet assembling mechanism is for adjusting a relative position between the imaging lens assembly and the image sensor. It is favorable for providing the auto-focus function or image stabilization. When the imaging lens assembly and the image sensor can be moved relatively along a vertical direction and a parallel direction, which can achieve the auto-focus function or image stabilization.

The magnet assembling mechanism is for providing a preload force for supporting the imaging lens assembly. In detail, the relative position between the imaging lens assembly and the image sensor can be maintained under a balancing condition by the preload force. Therefore, it is favorable for providing a stability of assembling.

The magnet assembling mechanism is for adjusting an aperture size of an aperture stop. Therefore, it is favorable for achieving the f-number adjusting function by the adjustable aperture stop.

The magnet assembling mechanism can further include a nano layer, which is disposed on the opaque layer. Therefore, it is favorable for maintaining the surface with low reflectance by further arranging the nano layer on the opaque layer.

The nano layer can include a plurality of nano particles arranged on a surface of the opaque layer irregularly. Thus, the graded refractive index can be provided by the stacking of the nano particles so as to decrease the reflectance.

The nano layer can include a plurality of nano protrusions arranged on a surface of the opaque layer irregularly. Therefore, it is favorable for providing the coating method with higher feasibility of mass production.

The nano layer can include a plurality of nano holes arranged on a surface of the opaque layer irregularly. Thus, the graded refractive index can be provided by the stacking of the nano particles so as to decrease the reflectance.

The opaque layer can include a plurality of micron particles for generating an irregular protruding structure on a surface of the opaque layer. Therefore, it is favorable for providing the surface of the magnet with lower reflectance by applying the coating design with better matting ability. In detail, the micron particles can have black carbon material, acrylic material, silicon dioxide, silica alumina or metal material, which is for absorbing incident light. The micron particles can form irregular protruding surface one the opaque layer, so that it is favorable for reducing the possibility of the generation of the stray light by effectively breaking the incident light with high intensity. The opaque layer can further include an opaque coating material, which is favorable for increasing the adhesion thereof so as to attach the micron particles to the magnet. The opaque coating material can be black pigments, organic solvents or resins, but will not be limited thereto.

When a surface of the opaque layer is measured according to an ISO25178 standard, a number of peaks per square millimeter of a microstructure layer is Ypd, the following condition is satisfied: 19000 1/mm²≤Ypd≤210000 1/mm². Further, the following condition can be satisfied: 25000 1/mm²≤Ypd≤120000 1/mm².

When the surface of the opaque layer is measured according to the ISO25178 standard, an equivalent line and an areal material ratio curve are obtained, a core height is defined by 0% to 100% of the equivalent line corresponding to the areal material ratio curve, a reduced peak is a portion of the areal material ratio curve higher than the core height, an areal material ratio that divides a core surface from the reduced peak is Ymr1, the following condition is satisfied: 7%≤Ymr1≤53%. Further, the following condition can be satisfied: 15%≤Ymr1≤45%.

When the surface of the opaque layer is measured according to the ISO25178 standard, the equivalent line and the areal material ratio curve are obtained, the core height is defined by 0% to 100% of the equivalent line corresponding to the areal material ratio curve, the reduced peak is the portion of the areal material ratio curve higher than the core height, an average height of the reduced peak is Aph, the following condition is satisfied: 0.5 μm≤Aph≤42.5 μm. Further, the following condition can be satisfied: 4.5 μm≤Aph≤35.5 μm.

When the surface of the opaque layer is measured according to the ISO25178 standard, a number of peaks of the microstructure layer larger than the core height and larger than 4 μm is Hpq, the following condition is satisfied: 0≤Hpq≤430. Further, the following condition can be satisfied: 15≤Hpq≤300.

The aforementioned conditions define the measurement according to the ISO25178 standard of the different partial areas of the opaque layer of the present disclosure, which can obtain different measured datum. The opaque layer of the present disclosure has at least one portion can satisfy one of the aforementioned conditions, that is, when the parameter of the surface roughness can satisfy any one of the aforementioned conditions, the reflection of visible light can by effectively destroyed which is suitable surface with coating for applying to the camera module.

Further, the opaque layer can cover the magnet completely. Therefore, it is favorable for providing the manufacturability of blackened magnet.

The present disclosure provides an electronic device, which includes the aforementioned camera module.

### 1st Embodiment

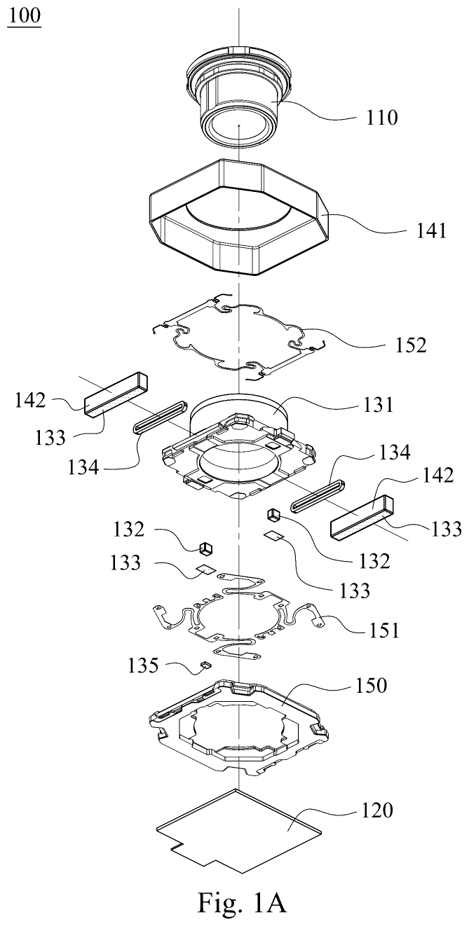

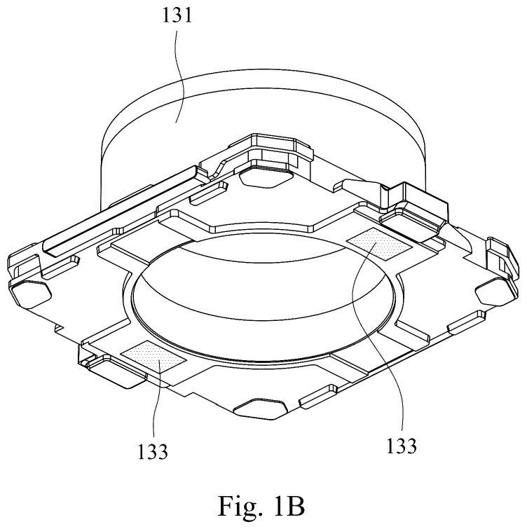

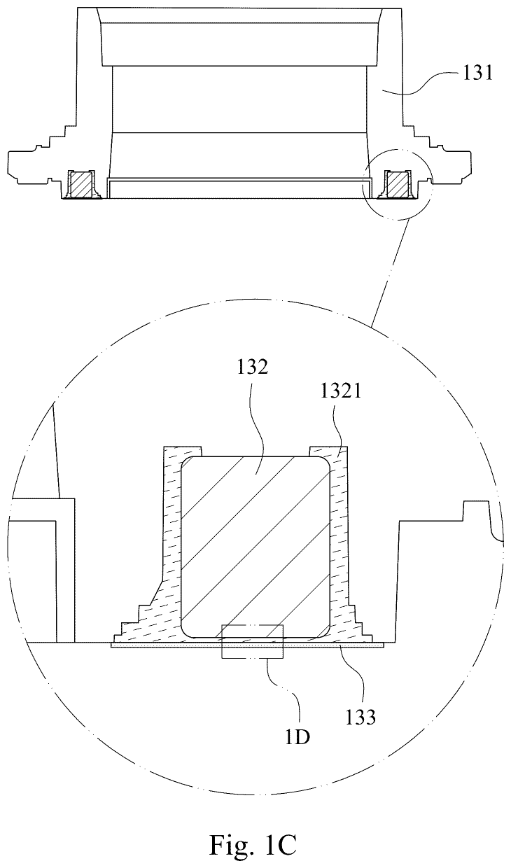

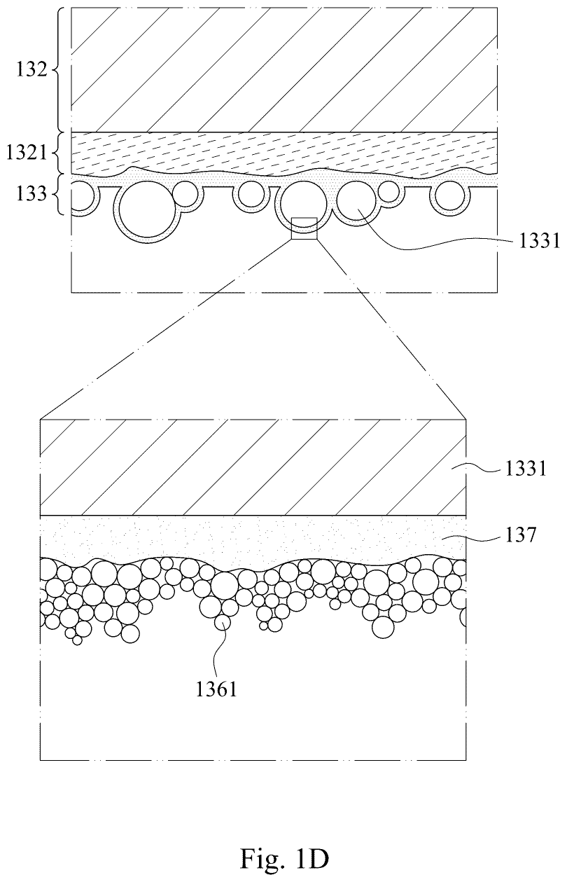

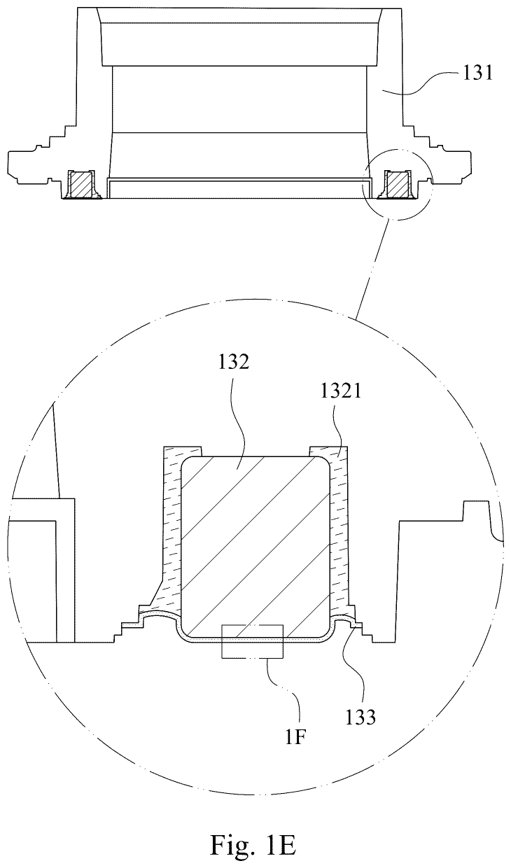

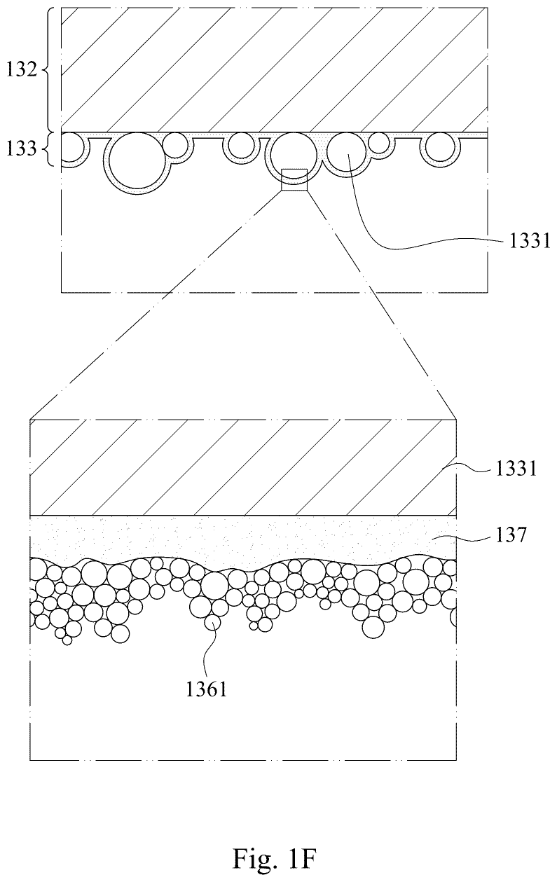

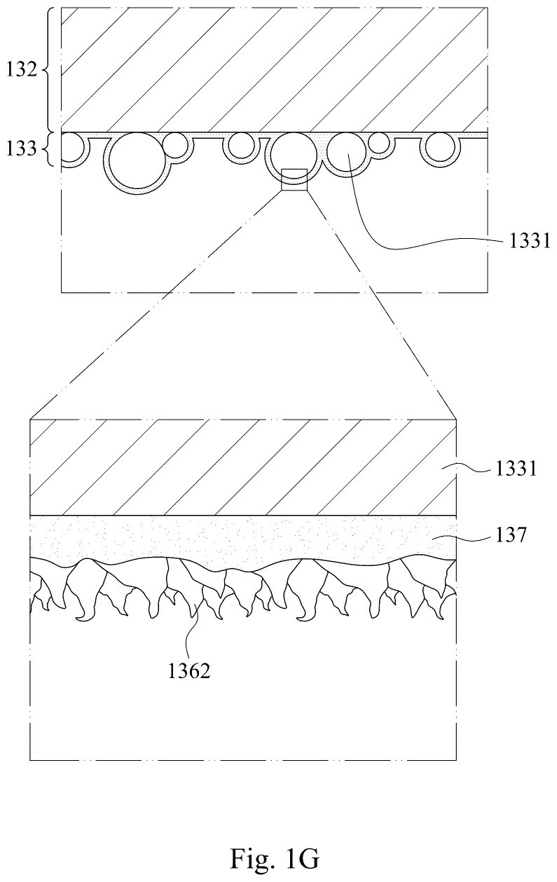

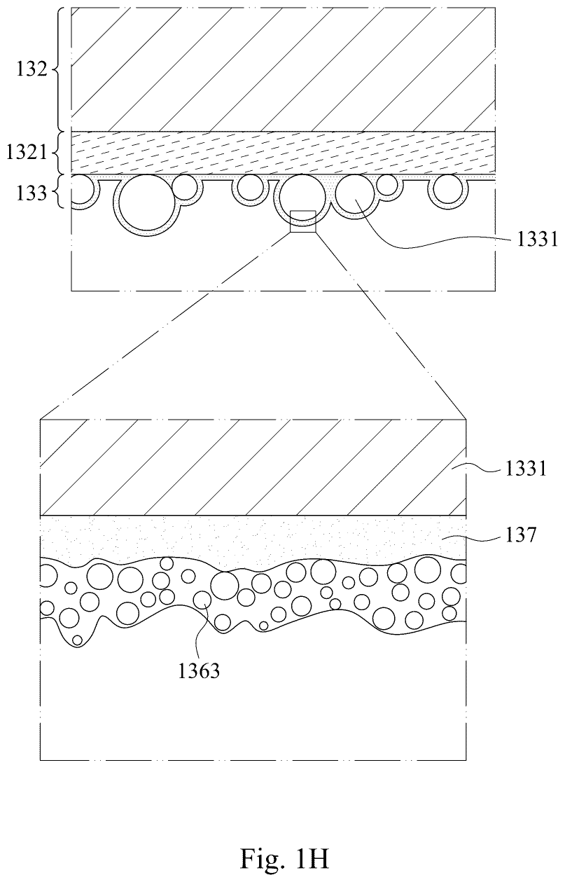

FIG. 1A is an exploded schematic view of a camera module 100 according to the 1st embodiment of the present disclosure. FIG. 1B is a schematic view of a first magnet holder 131 and an opaque layer 133 of the camera module 100 of FIG. 1A. In FIG. 1A and FIG. 1B, the camera module 100 includes an imaging lens assembly 110, an image sensor 120 and a magnet assembling mechanism (its reference numeral is omitted), wherein the image sensor 120 is for receiving an image signal of the imaging lens assembly 110, the magnet assembling mechanism is for defining a status of the image signal of the imaging lens assembly 110 corresponding to the image sensor 120. Specifically, according to the 1st embodiment, the magnet assembling mechanism is for realizing the auto-focus function and the circuit controlling function of the camera module 100.

In detail, the imaging lens assembly 110 can contain at least one lens element (its reference numeral is omitted), the image sensor 120 is disposed on an image side of the imaging lens assembly 110. The camera module 100 can further include a base 150, and the image sensor 120 can be positioned on the image side of the imaging lens assembly 110 by being disposed on the base 150.

The magnet assembling mechanism includes a magnet holder, a magnet and the opaque layer 133, wherein, according to the 1st embodiment of FIG. 1A, the magnet holder includes the first magnet holder 131 and a second magnet holder 141, the magnet includes at least one first magnet 132 and at least one second magnet 142, wherein a number of each of the at least one first magnet 132 and the at least one second magnet 142 is two. The first magnets 132 are disposed on the first magnet holder 131, the second magnets 142 are disposed on the second magnet holder 141. In FIG. 1B, a number of the opaque layer 133 is four, which are disposed on outer surfaces of the first magnets 132 and the second magnets 142, respectively. All of the opaque layers 133 face towards the image sensor 120.

The magnet assembling mechanism can further includes two coils 134 and a magnet sensing element 135. The two coils 134 are disposed on two outer sides of the first magnet holder 131, respectively, and are relatively disposed on the two 142 of the second magnet holder 141, respectively, wherein the two outer sides of the first magnet holder 131 are relative to each other. The first magnets 132 and the magnet sensing element 135 are disposed relatively.

Specifically, according to the 1st embodiment of FIG. 1A, the first magnet holder 131 is a movable magnet holder, the second magnet holder 141 is a fixed magnet holder, the first magnets 132 are sensing magnets, the second magnets 142 are driving magnets, but the present disclosure will not be limited thereto. Therefore, the magnet assembling mechanism is favorable for adjusting the relative location between the imaging lens assembly 110 and the image sensor 120. Further, the camera module 100 can further include supporting members 151, 152, which are connected to the first magnet holder 131, respectively, so that it is favorable for the movement and restore of the first magnet holder 131, and for providing a preload force for supporting the imaging lens assembly 110.

FIG. 1C is a schematic view of the first magnet holder 131, the first magnets 132 and the opaque layer 133 of the 1st example according to the 1st embodiment of FIG. 1A. In FIG. 1C, each of the first magnets 132 can be disposed at the first magnet holder 131 via the adhesive material 1321, the adhesive material 1321 can also applied between the opaque layer 133 and each of the first magnets 132. In other embodiments, the opaque layer can be directly disposed on the first magnet, and the present disclosure will not be limited thereto.

FIG. 1D is an enlarged schematic view of the portion 1D in FIG. 1C. In FIG. 1D, the opaque layer 133 can include a plurality of micron particles 1331 for generating an irregular protruding structure on a surface of the opaque layer 133. Further, the magnet assembling mechanism can further include a nano layer (its reference numeral is omitted) disposed on the opaque layer 133, wherein the nano layer includes a plurality of nano particles 1361 arranged on a surface of the opaque layer 133 irregularly. Furthermore, an opaque coating material 137 can be disposed on the micron particles 1331, which is favorable for attaching the micron particles 1331 onto each first magnets 132, and it is also favorable for attaching the nano layer onto the opaque layer 133 by arranging the nano particles 1361 of the nano layer on the opaque coating material 137. Moreover, the opaque layer 133 which is connected to each of the second magnets 142 can have the same or similar structures and features with the opaque layer 133 which is connected to each of the first magnets 132, and will not be described again herein.

According to the 1st example of the 1st embodiment, when a surface of the opaque layer 133 is measured according to an ISO25178 standard, a number of peaks per square millimeter of a microstructure layer is Ypd, an equivalent line and an areal material ratio curve are obtained, a core height is defined by 0% to 100% of the equivalent line corresponding to the areal material ratio curve, a reduced peak is a portion of the areal material ratio curve higher than the core height, an areal material ratio that divides a core surface from the reduced peak is Ymr1, an average height of the reduced peak is Aph, a number of peaks of the microstructure layer larger than the core height and larger than 4 μm is Hpq, and datum of the opaque layer 133 of 63 samples (TEST1 to TEST63) are disclosed in the following Table 1. It should be mentioned that the following embodiments and examples can also satisfy the parameters disclosed in Table 1.

TABLE 1

| | Parameter | | | |
|---|---|---|---|---|
| | Ypd | Ymr1 | Aph | |
| | (1/mm²) | (%) | (um) | Hpq |
| | Magnification | | | |
| | 480x | 480x | 2400x | 2400x |
| | Analyzed area | | | |
| | 500 um × | 500 um × | 100 um × | 100 um × |
| | 500 um | 500 um | 100 um | 100 um |
| | Measured size | | | |
| | 1024 × 768 | 1024 × 768 | 1024 × 768 | 1024 × 768 |
| | Measured distance | | | |
| | 0.5 um | 0.5 um | 0.2 um | 0.2 um |
| TEST1 | 81449 | 10.52 | 2.12 | 3 |
| TEST2 | 105688 | 15.87 | 6.65 | 32 |
| TEST3 | 66182 | 16.80 | 5.02 | 34 |
| TEST4 | 29425 | 15.00 | 7.14 | 95 |
| TEST5 | 54561 | 16.18 | 7.95 | 120 |
| TEST6 | 59599 | 14.00 | 7.98 | 50 |
| TEST7 | 89945 | 38.18 | 9.56 | 111 |
| TEST8 | 74526 | 16.33 | 2.41 | 0 |
| TEST9 | 101130 | 15.76 | 8.06 | 48 |
| TEST10 | 57714 | 7.32 | 4.06 | 14 |
| TEST11 | 49319 | 17.65 | 5.65 | 110 |
| TEST12 | 69232 | 21.65 | 18.41 | 202 |
| TEST13 | 35452 | 20.30 | 9.74 | 0 |
| TEST14 | 44524 | 26.72 | 6.69 | 41 |
| TEST15 | 54933 | 9.95 | 9.30 | 45 |
| TEST16 | 54865 | 13.92 | 10.55 | 51 |
| TEST17 | 65826 | 21.40 | 12.86 | 60 |
| TEST18 | 59339 | 21.81 | 12.23 | 65 |
| TEST19 | 42491 | 24.66 | 11.34 | 0 |
| TEST20 | 37109 | 27.26 | 17.17 | 64 |
| TEST21 | 38562 | 18.77 | 8.87 | 58 |
| TEST22 | 26416 | 23.71 | 11.74 | 126 |
| TEST23 | 90693 | 23.30 | 11.10 | 14 |
| TEST24 | 19245 | 52.17 | 41.12 | 288 |
| TEST25 | 84375 | 44.88 | 34.79 | 395 |
| TEST26 | 145955 | 13.95 | 1.04 | 0 |
| TEST27 | 27845 | 5.46 | 0.48 | 0 |
| TEST28 | 56246 | 9.99 | 1.95 | 0 |
| TEST29 | 48750 | 22.63 | 2.63 | 15 |
| TEST30 | 16788 | 3.18 | 1.79 | 0 |
| TEST31 | 140944 | 12.73 | 1.11 | 0 |
| TEST32 | 146147 | 12.29 | 1.19 | 0 |
| TEST33 | 155187 | 12.49 | 0.98 | 0 |
| TEST34 | 159981 | 13.87 | 1.65 | 1 |
| TEST35 | 142904 | 11.92 | 0.63 | 1 |
| TEST36 | 152850 | 12.62 | 0.86 | 0 |
| TEST37 | 152642 | 14.82 | 1.02 | 0 |
| TEST38 | 162486 | 12.65 | 0.86 | 0 |
| TEST39 | 164971 | 12.42 | 1.08 | 0 |
| TEST40 | 132809 | 11.93 | 1.33 | 0 |
| TEST41 | 156760 | 11.20 | 0.60 | 0 |
| TEST42 | 151033 | 11.58 | 0.97 | 0 |
| TEST43 | 158969 | 15.10 | 1.43 | 1 |
| TEST44 | 115561 | 11.13 | 1.47 | 0 |
| TEST45 | 47862 | 32.46 | 7.93 | 0 |
| TEST46 | 61292 | 27.20 | 12.33 | 15 |
| TEST47 | 146159 | 15.94 | 2.13 | 2 |
| TEST48 | 127454 | 15.26 | 1.75 | 0 |
| TEST49 | 122904 | 15.03 | 1.88 | 0 |
| TEST50 | 132192 | 14.93 | 1.35 | 0 |
| TEST51 | 138519 | 25.20 | 2.58 | 0 |
| TEST52 | 155695 | 10.71 | 0.96 | 0 |
| TEST53 | 130792 | 12.57 | 1.59 | 1 |
| TEST54 | 128907 | 10.09 | 2.19 | 1 |
| TEST55 | 141349 | 12.63 | 1.58 | 1 |
| TEST56 | 143538 | 11.85 | 1.45 | 1 |
| TEST57 | 149008 | 13.69 | 1.36 | 1 |
| TEST58 | 134673 | 18.95 | 2.47 | 1 |
| TEST59 | 131276 | 11.18 | 1.73 | 0 |
| TEST60 | 130187 | 10.84 | 1.65 | 0 |
| TEST61 | 129535 | 11.08 | 2.24 | 1 |
| TEST62 | 151609 | 12.76 | 1.44 | 1 |
| TEST63 | 150401 | 12.68 | 1.09 | 0 |

FIG. 1E is a schematic view of the first magnet holder 131, the first magnets 132 and the opaque layer 133 of the 2nd example according to the 1st embodiment of FIG. 1A. In FIG. 1E, each of the first magnets 132 can be disposed at the first magnet holder 131 via the adhesive material 1321, and the opaque layer 133 can be directly disposed on each of the first magnets 132.

FIG. 1F is an enlarged schematic view of the portion 1F in FIG. 1E. In FIG. 1F, the opaque layer 133 can include a plurality of micron particles 1331 for generating an irregular protruding structure on a surface of the opaque layer 133. Further, the magnet assembling mechanism can further include a nano layer (its reference numeral is omitted) disposed on the opaque layer 133, wherein the nano layer includes a plurality of nano particles 1361 arranged on a surface of the opaque layer 133 irregularly. Further, an opaque coating material 137 can be disposed on the micron particles 1331, which is favorable for attaching the micron particles 1331 onto each first magnets 132, and it is also favorable for attaching the nano layer onto the opaque layer 133 by arranging the nano particles 1361 of the nano layer on the opaque coating material 137.

FIG. 1G is an enlarged schematic view of the opaque layer 133, the micron particles 1331 and nano protrusions 1362 on the first magnet 132 of the 3rd example according to the 1st embodiment of FIG. 1A. In FIG. 1G, the opaque layer 133 can include a plurality of the micron particles 1331 for generating an irregular protruding structure on a surface of the opaque layer 133. Further, the magnet assembling mechanism can further include a nano layer disposed on the opaque layer 133, wherein the nano layer includes a plurality of the nano protrusions 1362 arranged on a surface of the opaque layer 133 irregularly. Furthermore, an opaque coating material 137 can be disposed on the micron particles 1331, which is favorable for attaching the micron particles 1331 onto each first magnets 132, and it is also favorable for attaching the nano layer onto the opaque layer 133 by arranging the nano protrusions 1362 of the nano layer on the opaque coating material 137.

FIG. 1H is an enlarged schematic view of the opaque layer 133, the micron particles 1331 and nano holes 1363 on the first magnet 132 of the 4th example according to the 1st embodiment of FIG. 1A. In FIG. 1H, the adhesive material 1321 can also applied between the opaque layer 133 and the first magnet 132. The opaque layer 133 can include a plurality of the micron particles 1331 or generating an irregular protruding structure on a surface of the opaque layer 133. Further, the magnet assembling mechanism can further include a nano layer (its reference numeral is omitted) disposed on the opaque layer 133, wherein the nano layer includes a plurality of the nano holes 1363 arranged on a surface of the opaque layer 133 irregularly. Furthermore, an opaque coating material 137 can be disposed on the micron particles 1331, which is favorable for attaching the micron particles 1331 onto each first magnets 132, and it is also favorable for attaching the nano layer onto the opaque layer 133 by arranging the nano holes 1363 of the nano layer on the opaque coating material 137.

### 2nd Embodiment

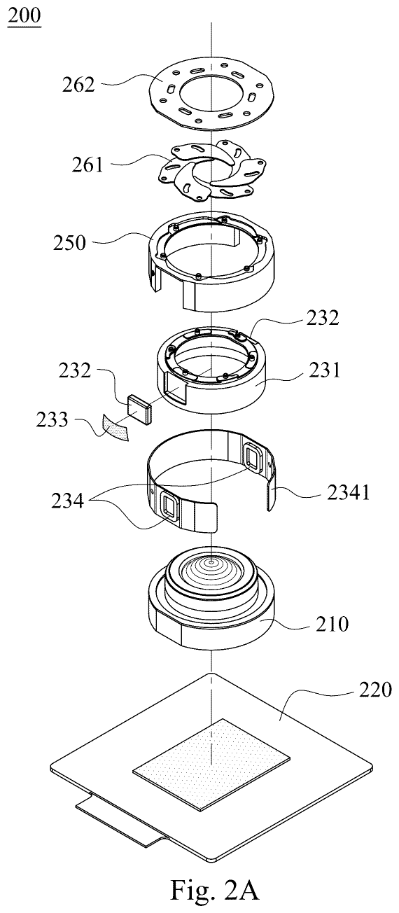

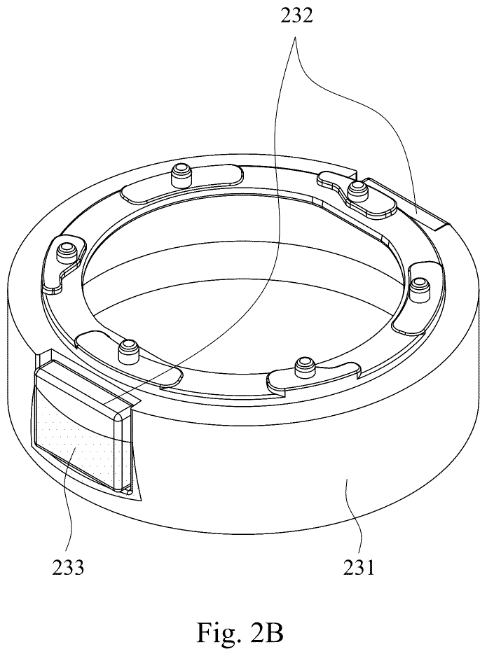

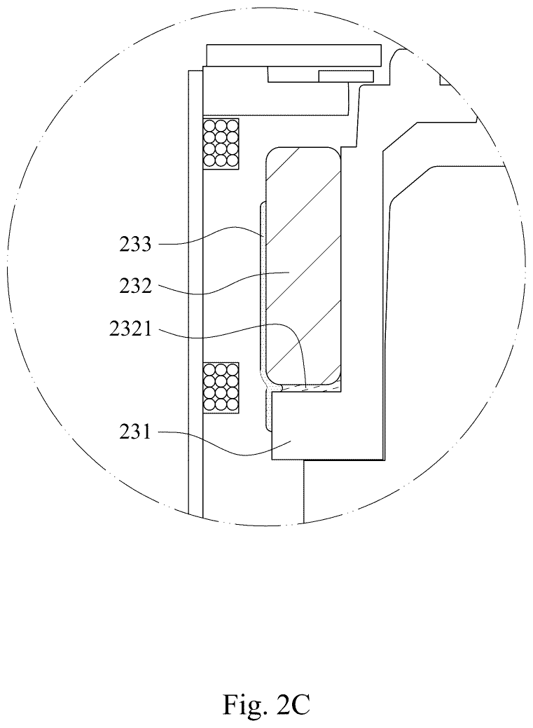

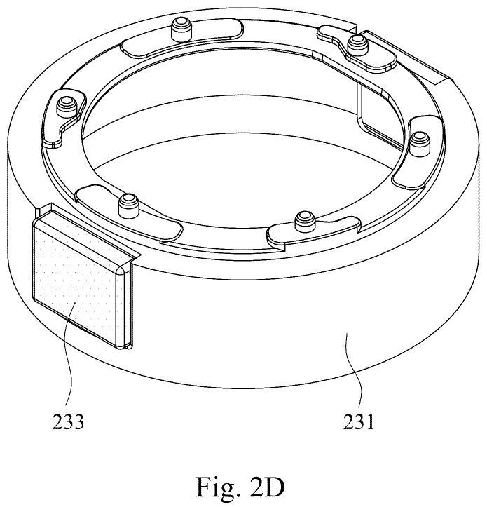

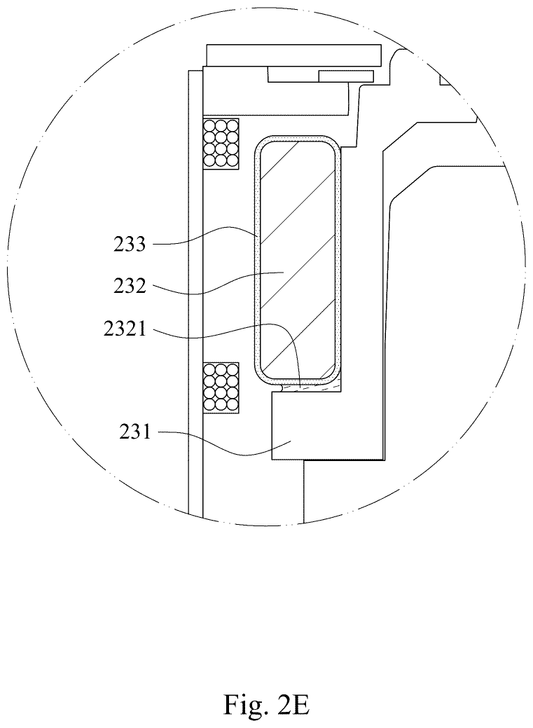

FIG. 2A is a schematic view of a camera module 200 according to the 2nd embodiment of the present disclosure. In FIG. 2A, the camera module 200 includes an imaging lens assembly 210, an image sensor 220 and a magnet assembling mechanism (its reference numeral is omitted), wherein the image sensor 220 is for receiving an image signal of the imaging lens assembly 210, the magnet assembling mechanism is for defining a status of the image signal of the imaging lens assembly 210 corresponding to the image sensor 220. Specifically, according to the 2nd embodiment, the magnet assembling mechanism is for realizing the f-number adjusting function of the camera module 200.

In detail, the imaging lens assembly 210 can contain at least one lens element (its reference numeral is omitted), the image sensor 220 is disposed on an image side of the imaging lens assembly 210.

According to the 2nd embodiment of FIG. 2A, the magnet assembling mechanism includes a magnet holder 231, magnets 232 and the opaque layers 233, wherein the number of the magnets 232 is two, which are disposed on the side of the magnet holder 231 and are relative to each other. The number of the opaque layers 233 is also two, which are disposed on the outer surfaces of the magnets 232, respectively.

The magnet assembling mechanism can further include two coils 234, which are relatively disposed with the magnets 232, respectively. In detail, the coils are disposed on the inner wall of the base 250 via the coil positioning element 2341. The base 250 covers the magnet holder 231, so that the coils 234 and the magnets 232 can be relative to each other. Further, an object-side end surface of the base 250 has an adjustable stop 261 and a fixing element 262 which is for positioning the adjustable stop 261 on the base 250. According to the 2nd embodiment, the magnets 232 of the magnet assembling mechanism can be driving magnet for adjusting the size of the adjustable stop 261 so as to control the f-number of the camera module 200.

FIG. 2B is a three-dimensional schematic view of the magnet holder 231, the magnets 232 and the opaque layers 233 of the 1st example according to the 2nd embodiment of FIG. 2A. FIG. 2C is a schematic view of the magnets 232, the opaque layers 233 and an adhesive material 2321 of the 1st example according to the 2nd embodiment of FIG. 2B. In FIG. 2B and FIG. 2C, the magnets 232 are disposed on the magnet holder 231 via the adhesive material 2321. A part of the opaque layers 233 is disposed on the outer surface of each of the magnets 232. Another part of the opaque layers 233 is connected to the adhesive material 2321 and the magnet holder 231 respectively.

FIG. 2D is a three-dimensional schematic view of the magnet holder 231 and the opaque layers 233 of the 2nd example according to the 2nd embodiment of FIG. 2A. FIG. 2E is a schematic view of the magnets 232, the opaque layers 233 and an adhesive material 2321 of the 2nd example according to the 2nd embodiment of FIG. 2D. In FIG. 2D and FIG. 2E, each of the opaque layers 233 covers each of the magnets 232 completely, the magnets 232 covered by the opaque layers 233 are disposed on the magnet holder 231 via the adhesive material 2321.

It should be mentioned that the opaque layers 233 of the 1st example and the 2nd example of the 2nd embodiment can be or similar to the opaque layer 133 according to any of the 1st example, the 2nd example and the 3rd example of the 1st embodiment, which with the micron particles 1331 and nano layer, etc., and will not be described again herein.

### 3rd Embodiment

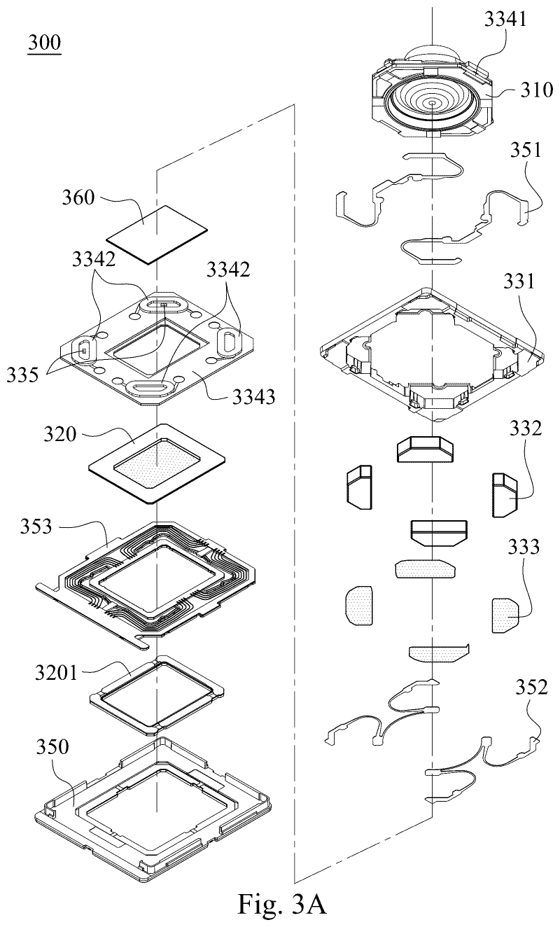

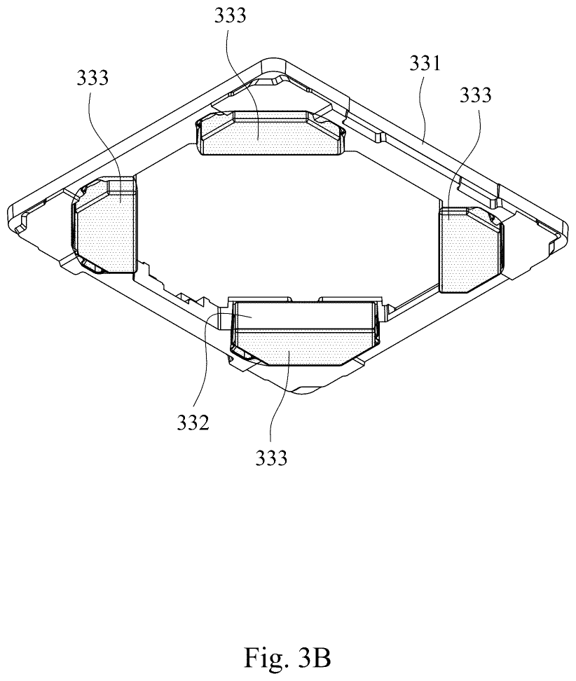

FIG. 3A is an exploded schematic view of a camera module 300 according to the 3rd embodiment of the present disclosure. FIG. 3B is a schematic view of a magnet holder 331, the magnets 332 and opaque layers 333 of the camera module 300 of FIG. 3A. In FIG. 3A and FIG. 3B, the camera module 300 includes an imaging lens assembly 310, an image sensor 320 and a magnet assembling mechanism (its reference numeral is omitted), wherein the image sensor 320 is for receiving an image signal of the imaging lens assembly 310, the magnet assembling mechanism is for defining a status of the image signal of the imaging lens assembly 310 corresponding to the image sensor 320. Specifically, according to the 3rd embodiment, the magnet assembling mechanism is for realizing the auto-focus function and the circuit controlling function of the camera module 300.

In detail, the imaging lens assembly 310 can contain at least one lens element (its reference numeral is omitted), the image sensor 320 is disposed on an image side of the imaging lens assembly 310.

The magnet assembling mechanism includes a magnet holder 331, the magnets 332 and the opaque layers 333, wherein, according to the 3rd embodiment of FIG. 3A and FIG. 3B, each of the number of the magnets 332 and the number of the opaque layers 333 is four, the four magnets 332 are disposed on four corners of the magnet holder 331, respectively. A part of each of the opaque layers 333 faces towards the image sensor 320.

The magnet assembling mechanism can further include coils 3341, 3342 and magnet sensing elements 335. In detail, the coil 3341 is disposed around the outer side of the imaging lens assembly 310, and relative to the four magnets 332 of the magnet holder 331. Further, the number of the coils 3342 is also four, which are disposed on four corners of a carrier member 3343. The carrier member 3343 is disposed on the image side of the magnet holder 331, and the four coils 3342 are relative to the four magnets 332. The number of the magnet sensing elements 335 are two, wherein the magnet sensing elements 335 are disposed on the carrier member 3343 and are adjacent to any two of the coils 3342, and relative to two of the magnets 332. Furthermore, the camera module 300 can further include a filter 360, which is disposed on the carrier member 3343 and relative to the image sensor 320. Moreover, the camera module 300 can further include supporting members 351, 352, 353, wherein the supporting member 351 is connected between the imaging lens assembly 310 and the magnet holder 331, the supporting members 352 are connected between the magnet holder 331 and the carrier member 3343, respectively, the supporting member 353 is connected between the carrier member 3343 and the base 350, wherein the supporting member 353 is for receiving and supporting the image sensor 320, and is connected to the base 350 via a fixing member 3201. Therefore, by the cooperation of the magnet assembling mechanism and the supporting members 351, 352, 353, a relative position between the imaging lens assembly 310 and the image sensor 320 can be adjusted, and a preload force for supporting the imaging lens assembly 310 can be provided.

It should be mentioned that the opaque layers 333 of the 3rd embodiment can be or similar to the opaque layer 133 according to any of the 1st example, the 2nd example and the 3rd example of the 1st embodiment, which with the micron particles 1331 and nano layer, etc., and will not be described again herein.

### 4th Embodiment

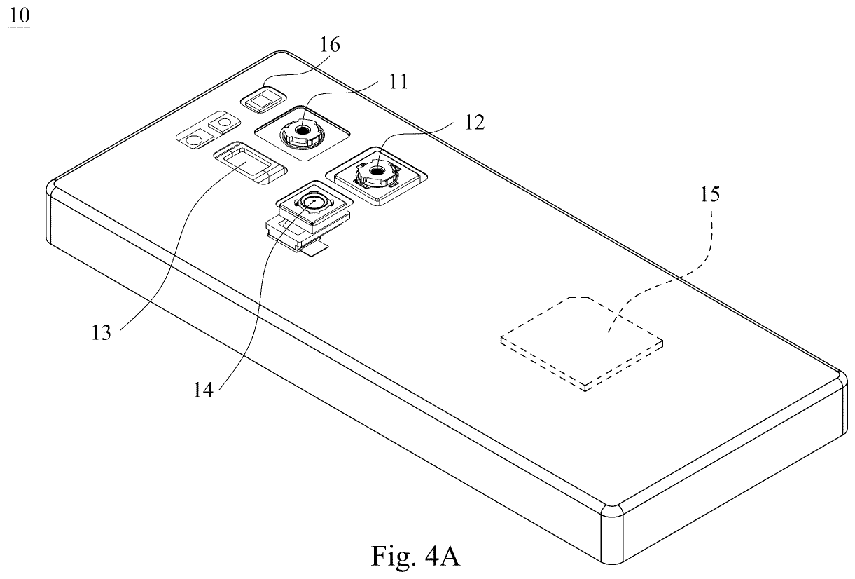

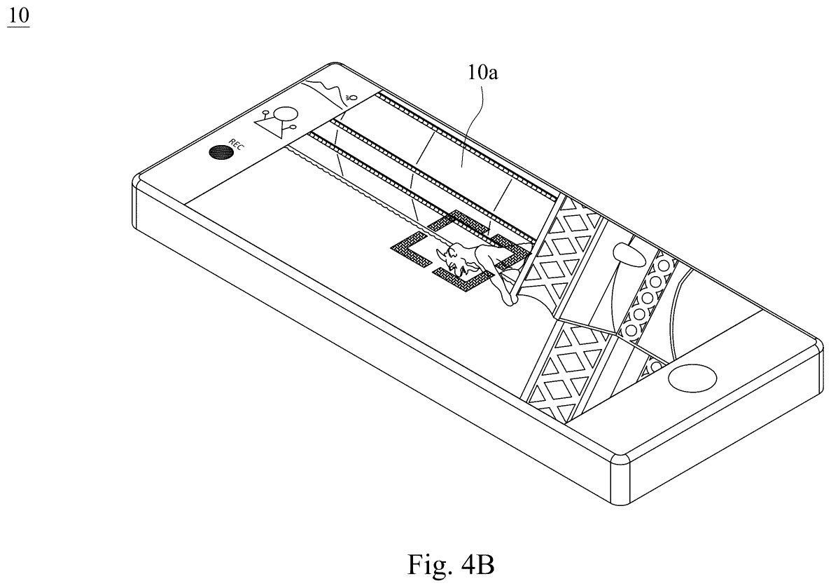

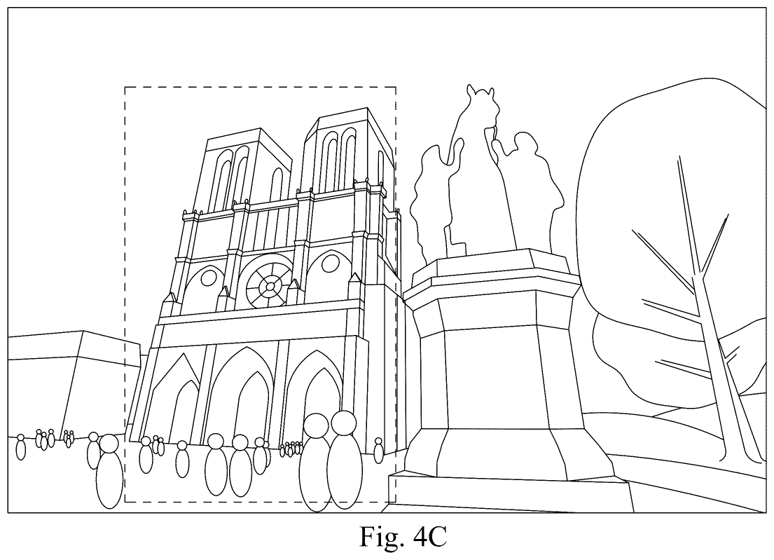

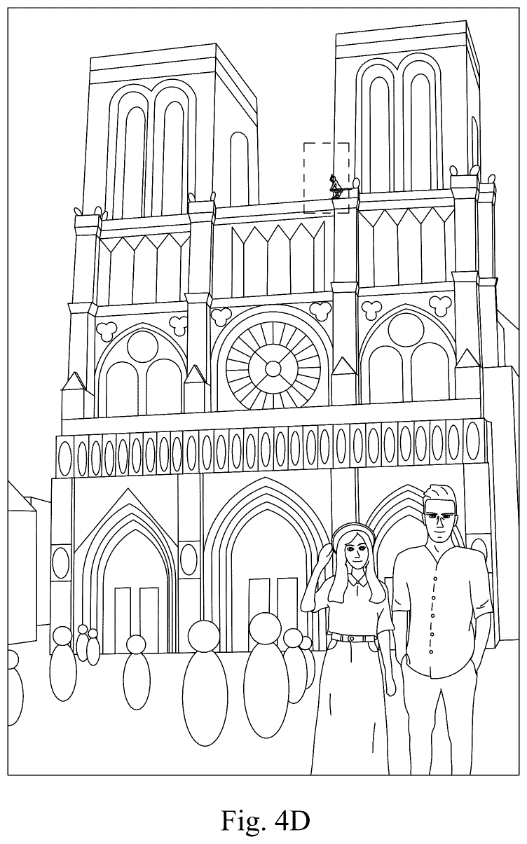

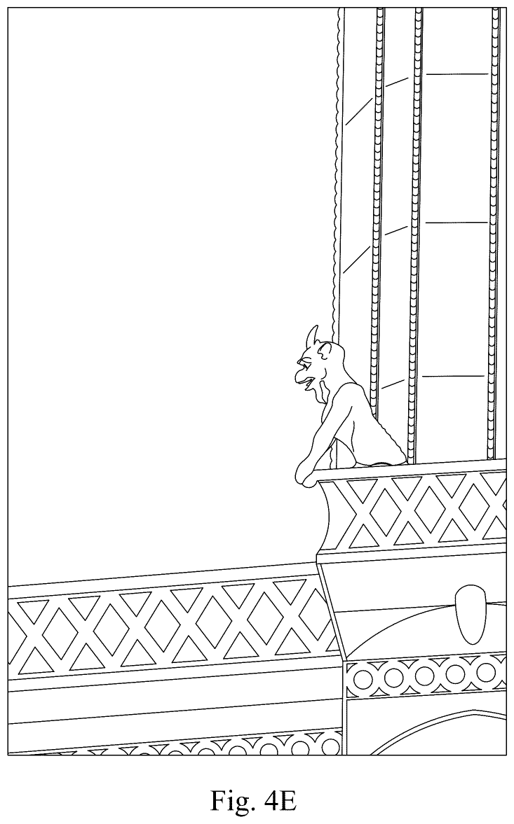

FIG. 4A is a schematic view of an electronic device 10 according to the 4th embodiment of the present disclosure. FIG. 4B is another schematic view of the electronic device 10 according to the 4th embodiment of FIG. 4A. As shown in FIG. 4A and FIG. 4B, the electronic device 10 is a smartphone. The electronic device 10 includes camera modules and a user interface 10a. In detail, the camera modules are a high-pixel camera module 11, an ultra-wide-angle camera module 12, and two telephoto camera modules 13, 14, and the user interface 10a is a touch screen, but the present disclosure is not limited thereto. Specifically, each of the camera modules can be any one of the examples according to the aforementioned 1st to 3rd embodiments, and will not be limited thereto.

A user enters a shooting mode via the user interface 10a. The user interface 10a is used to display the screen, and the shooting angle can be manually adjusted to switch between different camera modules. At this moment, the camera modules collect an imaging light on the respective image sensor (not shown in figures) and output electronic signals associated with images to an image signal processor (ISP) 15.

As shown in FIG. 4A, according to the camera specifications of the electronic device 10, the electronic device 10 can further include an optical anti-shake mechanism (not shown in figures). Further, the electronic device 10 can further include at least one focusing assisting module (not shown in figures) and at least one sensing component (not shown in figures). The focusing assisting module can be a flash module 16, an infrared distance measurement component, a laser focus module, etc. The flash module is for compensating the color temperature. The sensing component can have functions for sensing physical momentum and kinetic energies, such as an accelerator, a gyroscope, and a Hall effect element, so as to sense shaking or jitters applied by hands of the user or external environments. Thus the autofocus function and the optical anti-shake mechanism of the imaging lens assembly disposed on the electronic device 10 can function to obtain a great image quality and facilitate the electronic device 10 according to the present disclosure to have a capturing function with multiple modes, such as taking optimized selfies, high dynamic range (HDR) with a low light source, 4K resolution recording, etc. Furthermore, the user can visually see the captured image of the camera through the user interface 10a and manually operate the view finding range on the user interface 10a to achieve the auto focus function of what you see is what you get.

Furthermore, the camera modules, the optical anti-shake mechanism, the sensing component and the focusing assisting module can be disposed on a flexible printed circuit board (FPC) (not shown in figures) and electrically connected to the image signal processor 15 and so on via a connector (not shown in figures) so as to operate a picturing process. Recent electronic devices such as smartphones have a trend towards thinness and lightness. The camera modules and the related elements are disposed on a FPC and circuits are assembled into a main board of an electronic device by a connector. Hence, it can fulfill a mechanical design of a limited inner space of the electronic device and a requirement of a circuit layout and obtain a larger allowance, and it is also favorable for autofocus functions of the camera modules obtaining a flexible control via a touch screen of the electronic device. In the 4th embodiment, the electronic device 10 can include a plurality of the sensing components and a plurality of the focusing assisting modules, and the sensing components and the focusing assisting modules are disposed on an FPC and another at least one FPC (not shown in figures) and electrically connected to the image signal processor 15 and so on via a corresponding connector so as to operate a picturing process. In other embodiments (not shown in figures), the sensing components and auxiliary optical elements can be disposed on a main board of an electronic device or a board of the other form according to a mechanical design and a requirement of a circuit layout.

Furthermore, the electronic device 10 can further include, but not be limited to, a display, a control unit, a storage unit, a random-access memory (RAM), a read-only memory (ROM), or the combination thereof.

FIG. 4C is a schematic view of an image captured via the electronic device 10 according to the 4th embodiment of FIG. 4A. As shown in FIG. 4C, a larger ranged image can be captured via the ultra-wide-angle camera module 12, which has a function for containing more views.

FIG. 4D is another schematic view of the image captured via the electronic device 10 according to the 4th embodiment of FIG. 4A. As shown in FIG. 4D, a certain ranged and high-pixel image can be captured via the high-pixel camera module 11, which has a function for high resolution and low distortion.

FIG. 4E is the other schematic view of the image captured via the electronic device 10 according to the 4th embodiment of FIG. 4A. As shown in FIG. 4E, a far image can be captured and enlarged to a high magnification via the telephoto camera modules 13, 14, which has a function for a high magnification.

As shown in FIG. 4C to FIG. 4E, when an image is captured via different camera modules having various focal lengths and processed via a technology of an image processing, a zoom function of the electronic device 10 can be achieved.

### 5th Embodiment

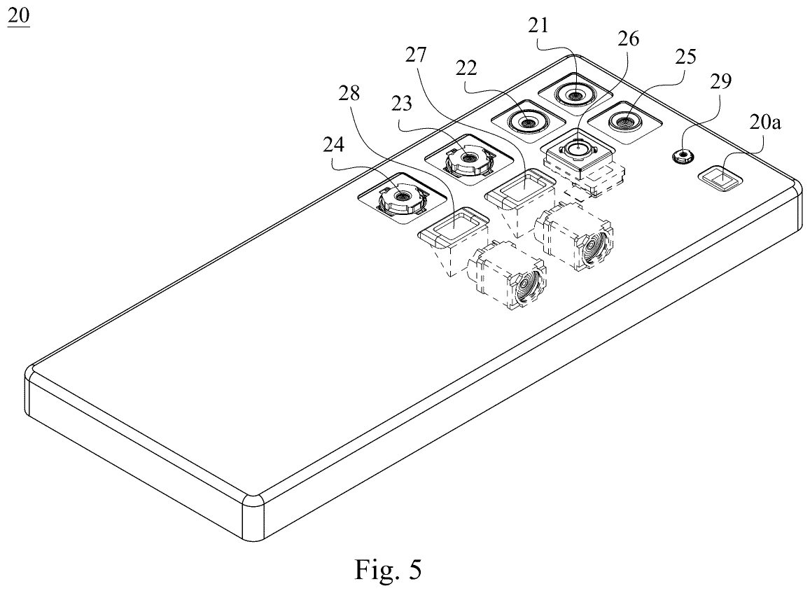

FIG. 5 is a schematic view of an electronic device 20 according to the 5th embodiment of the present disclosure. As shown in FIG. 5, the electronic device 20 is a smartphone. The electronic device 20 includes a plurality of camera modules. In detail, camera modules are two ultra-wide-angle camera modules 21, 22, two wide angle camera modules 23, 24, and four telephoto camera modules 25, 26, 27, 28, the camera module 29 is Time-Of-Flight (TOF) module and can be other types of camera module, which will not be limited to the present arrangement. Specifically, each of the camera modules can be any one of the examples according to the aforementioned 1st to 3rd embodiments, and will not be limited thereto.

Further, the camera modules 27, 28 can have folding function of the light path, but the present disclosure will not be limited thereto.

According to the camera specifications of the electronic device 20, the electronic device 20 can further include an optical anti-shake mechanism (not shown in figures). Further, the electronic device 20 can further include at least one focusing assisting module (not shown in figures) and at least one sensing component (not shown in figures). The focusing assisting module can be a flash module 20a, an infrared distance measurement component, a laser focus module, etc. The flash module 20a is for compensating the color temperature. The sensing component can have functions for sensing physical momentum and kinetic energies, such as an accelerator, a gyroscope, and a Hall effect element, so as to sense shaking or jitters applied by hands of the user or external environments. Thus, the autofocus function and the optical anti-shake mechanism of the camera modules disposed on the electronic device 20 can function to obtain a great image quality and facilitate the electronic device 6 according to the present disclosure to have a capturing function with multiple modes, such as taking optimized selfies, high dynamic range (HDR) with a low light source, 4K resolution recording, etc.

Furthermore, all of other structures and dispositions according to the 5th embodiment are the same as the structures and the dispositions according to the 4th embodiment, and will not be described again herein.

### 6th Embodiment

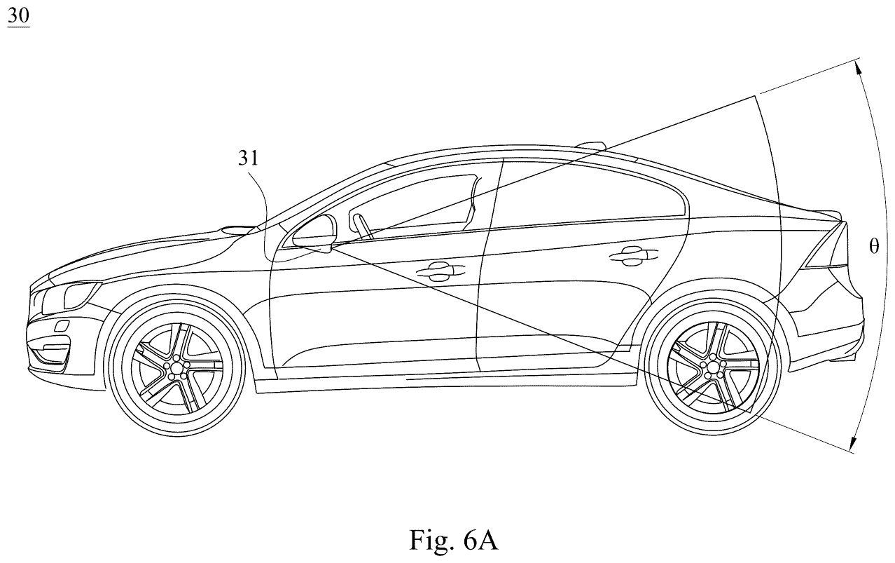

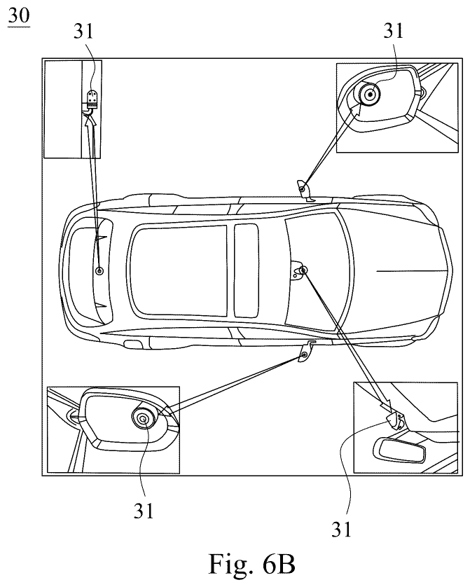

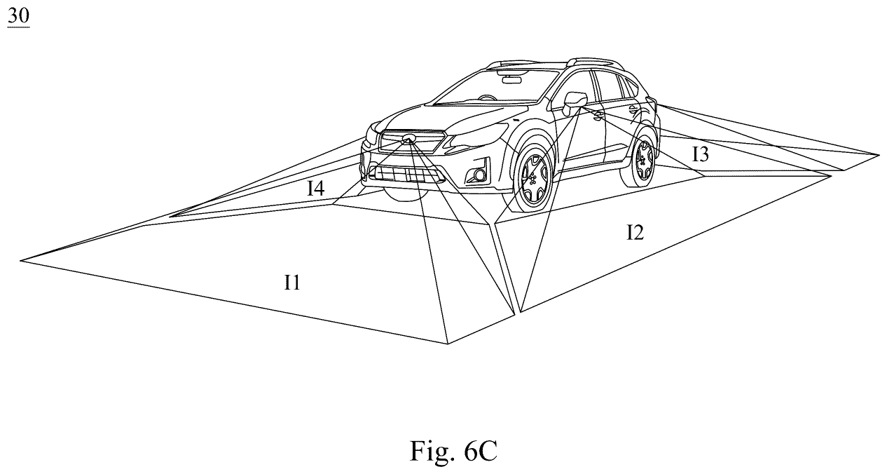

FIG. 6A is a schematic view of a vehicle instrument 30 according to the 6th embodiment of the present disclosure. FIG. 6B is another schematic view of the vehicle instrument 30 according to the 6th embodiment in FIG. 6A. FIG. 6C is another schematic view of the vehicle instrument 30 according to the 6th embodiment in FIG. 6A. In FIGS. 6A to 6C, the vehicle instrument 30 includes a plurality of camera modules 31. According to the 6th embodiment, a number of the camera modules 31 is six, and the camera modules 31 can be the camera module according to any one example of the aforementioned 1st embodiment to 3rd embodiment, but the present disclosure is not limited thereto.

In FIGS. 6A and 6B, the camera modules 31 are automotive camera modules, two of the camera modules 31 are located under rearview mirrors on a left side and a right side, respectively, and the aforementioned camera modules 31 are configured to capture the image information of a visual angle θ. In particular, the visual angle θ can satisfy the following condition: 40 degrees<θ<90 degrees. Therefore, the image information in the regions of two lanes on the left side and the right side can be captured.

In FIG. 6B, another two of the camera modules 31 can be disposed in the inner space of the vehicle instrument 30. In particular, the aforementioned two camera modules 31 are disposed on a location close to the rearview mirror inside the vehicle instrument 30 and a location close to the rear car window, respectively. Moreover, the camera modules 31 can be further disposed on the rearview mirrors of the vehicle instrument 30 on the left side and the right side except the mirror surface, respectively, but the present disclosure is not limited thereto.

In FIG. 6C, another two of the camera modules 31 can be disposed on a front end of the vehicle instrument 30 and a rear end of the vehicle instrument 30, respectively. By disposing the camera modules 31 on the front end and the rear end of the vehicle instrument 30 and under the rearview mirror on the left side of the vehicle instrument 30 and the right side of the vehicle instrument 30, it is favorable for the drivers obtaining the external space information in addition to the driving seat, such as the external space informations I1, I2, I3, I4, but the present disclosure is not limited thereto. Therefore, more visual angles can be provided to reduce the blind spot, so that the driving safety can be improved. Further, the traffic information outside of the vehicle instrument 30 can be recognized by disposing the camera modules 30 on the periphery of the vehicle instrument 30, so that the function of the automatic driving assistance can be achieved.

The foregoing description, for purpose of explanation, has been described with reference to specific examples. It is to be noted that Tables show different data of the different examples; however, the data of the different examples are obtained from experiments. The examples were chosen and described in order to best explain the principles of the disclosure and its practical applications, to thereby enable others skilled in the art to best utilize the disclosure and various examples with various modifications as are suited to the particular use contemplated. The examples depicted above and the appended drawings are exemplary and are not intended to be exhaustive or to limit the scope of the present disclosure to the precise forms disclosed. Many modifications and variations are possible in view of the above teachings.

What is claimed is:

1. A camera module, comprising:
an imaging lens assembly;
an image sensor for receiving an image signal of the imaging lens assembly; and
a magnet assembling mechanism for defining a status of the image signal of the imaging lens assembly corresponding to the image sensor, wherein the magnet assembling mechanism comprises:
a magnet holder;
a magnet disposed at the magnet holder; and
an opaque layer disposed on an outer surface of the magnet.

2. The camera module of claim 1, wherein the opaque layer has a part facing towards a direction towards the image sensor.

3. The camera module of claim 1, wherein the magnet assembling mechanism further comprises:
a coil, the magnet and the coil disposed relatively.

4. The camera module of claim 1, wherein the magnet assembling mechanism further comprises:
a magnet sensing element, the magnet and the magnet sensing element disposed relatively.

5. The camera module of claim 1, wherein the magnet assembling mechanism is for adjusting a relative position between the imaging lens assembly and the image sensor.

6. The camera module of claim 1, wherein the magnet assembling mechanism is for providing a preload force for supporting the imaging lens assembly.

7. The camera module of claim 1, wherein the magnet assembling mechanism is for adjusting an aperture size of an aperture stop.

8. The camera module of claim 1, wherein the magnet assembling mechanism further comprises:
a nano layer disposed on the opaque layer.

9. The camera module of claim 8, wherein the nano layer comprises a plurality of nano particles arranged on a surface of the opaque layer irregularly.

10. The camera module of claim 8, wherein the nano layer comprises a plurality of nano protrusions arranged on a surface of the opaque layer irregularly.

11. The camera module of claim 8, wherein the nano layer comprises a plurality of nano holes arranged on a surface of the opaque layer irregularly.

12. The camera module of claim 1, wherein the opaque layer comprises:
a plurality of micron particles for generating an irregular protruding structure on a surface of the opaque layer.

13. The camera module of claim 2, wherein when a surface of the opaque layer is measured according to an ISO25178 standard, a number of peaks per square millimeter of a microstructure layer is Ypd, the following condition is satisfied:
$$190 \; 001 / {mm}^{2} \leq Ypd \leq 2100001 / {mm}^{2} .$$

14. The camera module of claim 13, wherein when the surface of the opaque layer is measured according to the ISO25178 standard, the number of the peaks per square millimeter of the microstructure layer is Ypd, the following condition is satisfied:
$$250 \; 001 / {mm}^{2} \leq Ypd \leq 1200001 / {mm}^{2} .$$

15. The camera module of claim 2, wherein when a surface of the opaque layer is measured according to an ISO25178 standard, an equivalent line and an areal material ratio curve are obtained, a core height is defined by 0% to 100% of the equivalent line corresponding to the areal material ratio curve, a reduced peak is a portion of the areal material ratio curve higher than the core height, an areal material ratio that divides a core surface from the reduced peak is Ymr1, the following condition is satisfied:
7%≤Ymr1≤53%.

16. The camera module of claim 15, wherein when the surface of the opaque layer is measured according to the ISO25178 standard, the areal material ratio that divides the core surface from the reduced peak is Ymr1, the following condition is satisfied:
15%≤Ymr1≤45%.

17. The camera module of claim 2, wherein when a surface of the opaque layer is measured according to an ISO25178 standard, an equivalent line and an areal material ratio curve are obtained, a core height is defined by 0% to 100% of the equivalent line corresponding to the areal material ratio curve, a reduced peak is a portion of the areal material ratio curve higher than the core height, an average height of the reduced peak is Aph, the following condition is satisfied:
0.5 μm≤Aph≤42.5 μm.

18. The camera module of claim 17, wherein when the surface of the opaque layer is measured according to the ISO25178 standard, the average height of the reduced peak is Aph, the following condition is satisfied:
4.5 μm≤Aph≤35.5 μm.

19. The camera module of claim 2, wherein when a surface of the opaque layer is measured according to an ISO25178 standard, a number of peaks of a microstructure layer larger than a core height and larger than 4 μm is Hpq, the following condition is satisfied:
0≤Hpq≤430.

20. The camera module of claim 19, wherein when the surface of the opaque layer is measured according to the ISO25178 standard, the number of peaks of the microstructure layer larger than the core height and larger than 4 μm is Hpq, the following condition is satisfied:
15≤Hpq≤300.

21. The camera module of claim 1, wherein the opaque layer covers the magnet completely.

22. An electronic device, comprising:
the camera module of claim 1.
